(19) United States
(12) Patent Application Publication
(10) Pub. No.: US 2010/0205191 A1
(43) Pub. Date: Aug. 12, 2010

(54) USER ACCESS TIME BASED CONTENT FILTERING

(75) Inventors: Fan-Hsuan Fred Meng, Fengshan City (TW); Yu-Chuan Ange Wei, Tainan City 701 (TW); Chi-Hsin Bruce Tseng, Sanchong City (TW)

Correspondence Address: FIALA & WEAVER, P.L.L.C.;C/O CPA GLOBAL, P.O. BOX 52050, MINNEAPOLIS, MN, 55402, US

(73) Assignee: Yahoo! Inc., Sunnyvale, CA (US)

(21) Appl. No.: 12/367,776

(22) Filed: Feb. 9, 2009

(51) Int. Cl. G06F 17/30

(52) U.S. Cl. 707/758; 707/E17.108

(57) ABSTRACT

A system and method for user access time based content filtering for Internet materials. A user access time distribution pattern of one or more known offensive Internet files may be compiled and stored as a model. The user access time distribution pattern of a target Internet file may be calculated and compared with the model. If the user access time distribution pattern of the target Internet file is sufficiently similar to the model, the target Internet file may be identified as offensive, and may be so labeled.

### BACKGROUND

1. Field of the Invention

The present invention relates generally to content filtering on the Internet.

2. Description of Related Art

It is difficult to identify offensive Internet materials, such as images, photos, cartoons, videos and websites with violent or pornographic content. Currently available solutions are complicated and time consuming, since they usually require looking at Internet materials, one by one, to find the materials that are offensive. In addition, there is no solution that can be used across different types of Internet materials, e.g., pictures and video clips. Therefore, it may be desirable to provide a method which may identify offensive Internet materials more effectively.

### BRIEF DESCRIPTION OF THE DRAWING FIGURES

Embodiments of the present invention are described herein with reference to the accompanying drawings, similar reference numbers being used to indicate functionally similar elements.

FIG. 1 illustrates a system for user access time based content filtering for Internet materials according to one embodiment of the present invention.

FIGS. 2A, 2B and 2C illustrate exemplary user access time distribution patterns used in one embodiment of the present invention.

FIG. 3 illustrates a flowchart of a method for user access time based content filtering for Internet materials according to one embodiment of the present invention.

FIG. 4 illustrates an embodiment of using a method for user access time based content filtering for Internet materials with a search engine.

### DETAILED DESCRIPTION

The present invention provides a system and method for user access time based content filtering for Internet materials. Since users tend to look at offensive Internet materials surreptitiously, the time(s) when a user might access offensive Internet materials may have a unique distribution pattern over the course of a day, e.g., close to zero during the day and peaking in the late night to early morning hours. Weekends and holidays also might be times when access to offensive sites may increase. Essentially, any time that a user wishes to remain unobserved while perusing such offensive sites might be a candidate for a particular offensive site. Embodiments of the present invention use this unique user access time distribution pattern to identify offensive Internet materials. A user access time distribution pattern of one or more known offensive Internet files may be compiled and stored as a model. The user access time distribution pattern of a target Internet file may be calculated and compared with the model. If the user access time distribution pattern of the target Internet file is sufficiently similar to the model, the target Internet file may be identified as an offensive one, and may be so labeled. When the invention is used with a search engine as a pre-screen method, an offensive Internet file may be screened out so that it does not appear at all, or given a ranking sufficiently low for it to appear only at or near the end of a search result list. The method is effective and can be used across different material types. The invention may be carried out by computer-executable instructions, such as program modules. Advantages of the present invention will become apparent from the following detailed description.

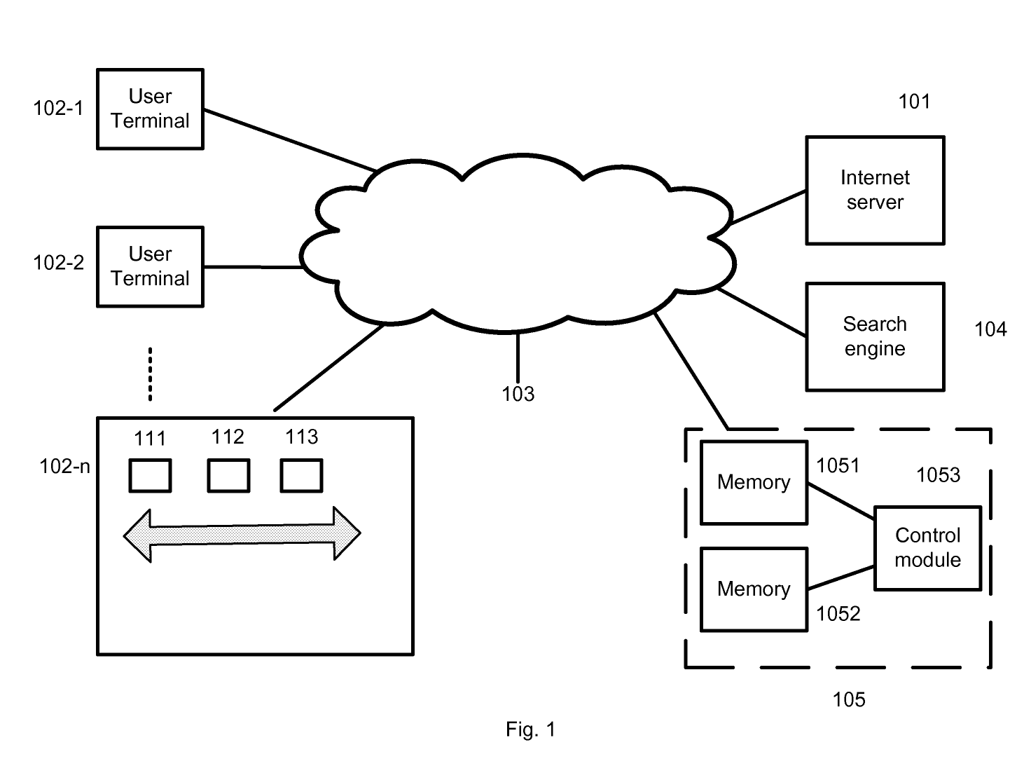

FIG. 1 illustrates a system for user access time based content filtering for Internet materials according to one embodiment of the present invention. As shown, an Internet server 101 may communicate over a network 103 with a number of user terminals 102-1, 102-2, . . . 102-n. The Internet server 101 may be a computer system and may control the operation of a website or a blog which may include images, articles, video clips, pictures and other content.

The user terminals 102 may be personal computers, handheld or laptop devices, microprocessor-based systems, set top boxes, or programmable consumer electronics. Each user terminal may include one or more of a screen 111, an input device 112, a processing unit 113, memory devices, and a system bus coupling various components. An operating system of the user terminal may respond to a user input by managing tasks and internal system resources and processing system data.

Each user terminal may have a browser application configured to receive and display web pages, which may include text, graphics, multimedia, etc. The web pages may be based on, e.g., HyperText Markup Language (HTML) or extensible markup language (XML).

A user may search the Internet for content he is interested in with a search engine 104.

Network connectivity may be wired or wireless, using one or more communications protocols, as will be known to those of ordinary skill in the art.

A content filter 105 may have a first memory 1051 for storing a model of user access time distribution pattern for offensive Internet materials, a second memory 1052 for storing user access time information for one or more target Internet files, and a control module 1053 for determining whether a target Internet file is offensive.

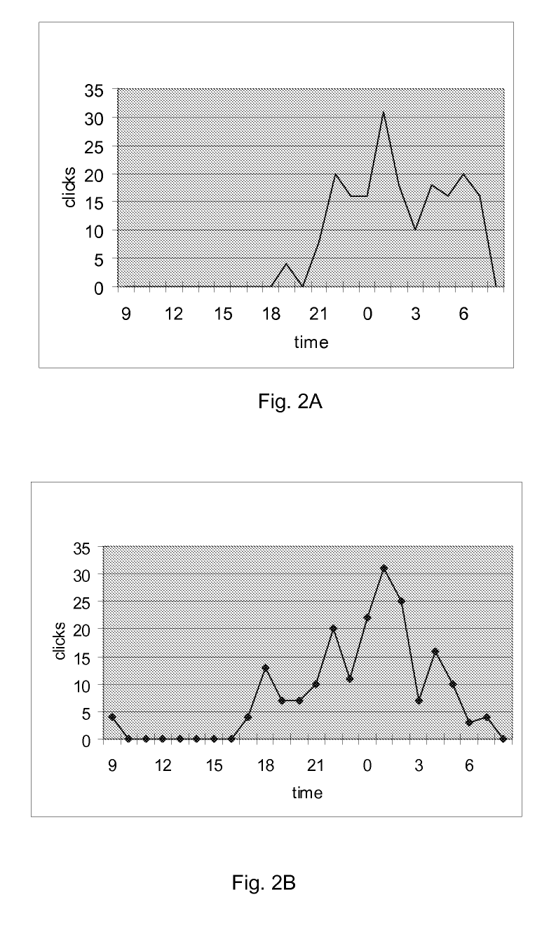

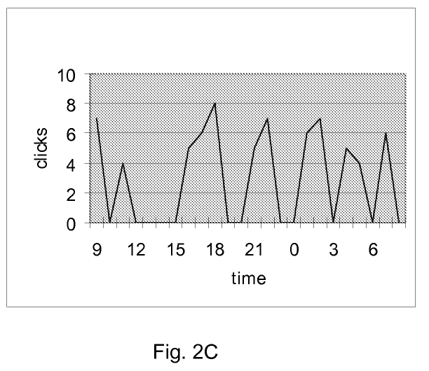

The model of user access time distribution pattern for offensive Internet materials in the memory 1051 may be obtained in advance. In one embodiment, the user access time information for a known offensive Internet file over a certain period of time, e.g., 2 days, may be collected and compiled, and its distribution pattern may be inferred. As shown in FIG. 2A, the distribution pattern for the user access time information for a known offensive Internet file may be a waveform, showing that accesses are close to zero from 9 am to 6 pm, peak around lam, steadily increase between 6 pm and 1 am and decrease between 1 am and 9 am. In one embodiment, the model of user access time distribution pattern for offensive Internet materials may be some features, e.g., 80% of accesses occur between 6 pm to 9 am, or accesses between 1 am and 2 am are 30 times the number of accesses between 1 pm and 2 pm. User access time distribution pattern for a few more known offensive Internet files may be compiled and consolidated so as to improve the model's accuracy.

The control module 1053 may collect user access time information of a target Internet file (e.g., the time of each click) over a certain period of time (e.g., 3 days), compile a user access time distribution pattern for the target Internet file and store it in the memory 1052. The user access time distribution pattern for the target Internet file may be a waveform, or features of access time. The user access time is based on the user's time zone. In one embodiment, the user access time distribution pattern for the target Internet file may be calculated time zone by time zone. The distribution patterns of other time zones may be used to confirm the distribution pattern in one time zone, or distribution patterns of multiple time zones may be consolidated into one user access time distribution pattern for the target Internet file to improve accuracy.

After the user access time distribution model of the target Internet file is compiled, the control module 1053 may compare it with the model of user access time distribution pattern of offensive Internet files, and determine whether the distribution pattern of the target Internet file is similar to the model. For example, if the model is a waveform, and the waveform of the user access time distribution pattern of a target Internet file has a roughly similar contour, as shown in FIG. 2B, the control module 1053 may determine that the target Internet file is offensive. If the waveform of the user access time distribution pattern of the target Internet file has a very different contour, as shown in FIG. 2C, the control module 1053 may determine that the target Internet file is not offensive. In FIG. 2C, for example, there are several access peaks, both during what might be considered normal or peak viewing hours and during night time or very early morning access times. Other access patterns which can denote access of non-offensive Internet materials can be readily discerned.

In another example, if the model includes a threshold, e.g., 80% of the clicks on the target occur between 6 pm and 9 am, and more than 80% of the clicks on the target Internet file occur between 6 pm and 9 am, the control module 1053 may determine that the target Internet file is offensive.

If the control module 1053 determines that a target Internet file is offensive, it may so label the target Internet file. When an Internet file labeled as offensive is included in a search result list, the search engine 104 may screen it out so that it does not appear at all, or give it a sufficiently low ranking that it will not appear until at or near the end of the search result list.

FIG. 1 is only an embodiment used to illustrate the invention and is not intended to limit the scope of the invention. For example, although the content filter 105 is shown as a stand alone part in FIG. 1, it may be integrated into the search engine 104 or other parts of the Internet, e.g., a switch. In another example, the memory 1051 and 1052 may be combined into one memory.

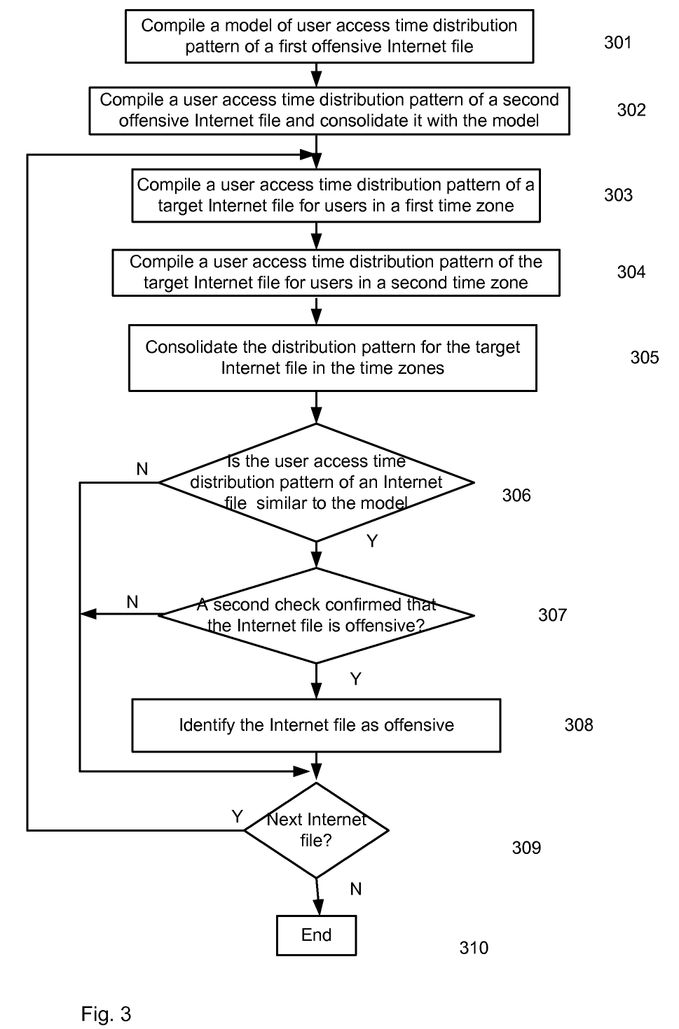

FIG. 3 illustrates a flowchart of a method for user access time based content filtering for Internet materials according to one embodiment of the present invention.

At 301, a model of user access time distribution pattern of offensive Internet files may be compiled. In one embodiment, user access time information for a known offensive Internet file over a certain period of time, e.g., 3 days, may be collected and compiled, and its distribution pattern may be inferred and stored as a model distribution pattern in the memory 1051. The model distribution pattern may be a waveform, as shown in FIG. 2A. Alternatively, the model distribution pattern may include some thresholds, e.g., 85% of the clicks on an Internet file occur between 6 pm and 9 am.

At 302, user access time distribution pattern for a second known offensive Internet file may be compiled and consolidated with the model to improve its accuracy. User access time distribution patterns of a greater number of known offensive Internet files may be compiled and consolidated with the model, but the model used in the invention should not be considered as limited to any particular number of patterns.

At 303, user access time information of a target Internet file for users in one time zone may be collected. The user access time information may be, e.g., the time for each click, and may be collected over a certain period of time, e.g., 3 days. The collected user access time information may be stored in the memory 1052 and compiled into a distribution pattern. The distribution pattern for the target Internet file may be a waveform, or some thresholds.

At 304, user access time information of the target Internet file for users in a second time zone may be collected and stored in the memory 1052, and a user access time distribution pattern may be compiled for users in the second time zone. 301-305 may be repeated to improve accuracy of the distribution pattern.

At 305, the user access time distribution patterns of the first and second time zones may be consolidated into one distribution pattern for the target Internet file. Access time information for users in more time zones may be collected and used to improve accuracy of the user access time distribution pattern for the target Internet file.

At 306, the user access time distribution pattern of the target Internet file may be compared with the model user access time distribution pattern for offensive Internet files. If it is not similar to the model, the process may proceed to 309 to conduct the next comparison.

At 307, if the target Internet file's user access time distribution pattern is similar to the model, e.g., its waveform has essential characteristics of the model, or it exceeds the threshold of the model, a second check may be performed, e.g., by checking skin color or body shape on an image with a machine or by looking at the Internet file. If the second check indicates that the target Internet file is not offensive, the process may proceed to 309.

If the second check confirms that the target Internet file is offensive, it may be so labeled at 308.

At 309, it may be determined whether there is another Internet file that needs to be checked. If yes, the process may return to 303, and 303-309 may repeat. Otherwise, the process may end at 310. In this way, one by one and gradually, all Internet files may be screened to determine whether they are offensive.

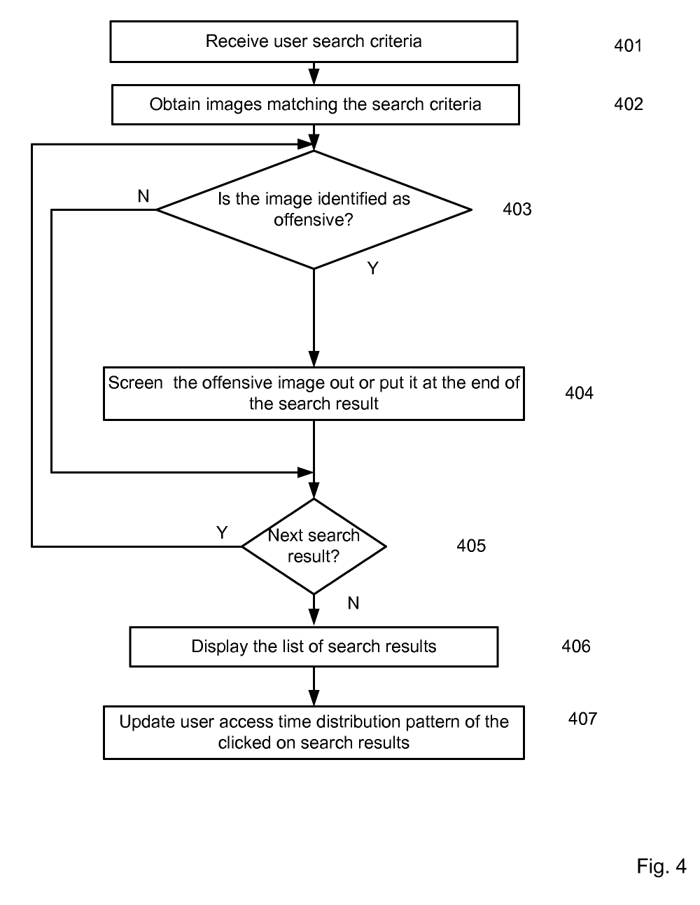

FIG. 4 illustrates an embodiment of using a method for user access time based content filtering for Internet materials with a search engine.

At 401, the search engine 104 shown in FIG. 1 may receive some search criteria from a user.

At 402, the search engine 104 may obtain a list of images, or search results, matching the search criteria.

At 403, the search engine 104 may determine whether an image in the list is labeled as offensive. If it is not, the process may proceed to 405.

If an image is labeled as offensive, at 404, the search engine 104 may remove it from the list or lower its ranking to put it at or near the end of the list.

At 405, it may be determined whether there is another image in the list. If yes, the process may return to 403 and 403-405 may repeat.

At 406, after all images in the list have been screened, the search results may be displayed, with the Internet files labeled as offensive removed or put at the end of the list of search results.

At 407, if the user clicks on an image in the list, the user access time distribution pattern of that file may be updated.

Several features and aspects of the present invention have been illustrated and described in detail with reference to particular embodiments by way of example only, and not by way of limitation. Those of skill in the art will appreciate that alternative implementations and various modifications to the disclosed embodiments are within the scope and contemplation of the present disclosure. Therefore, it is intended that the invention be considered as limited only by the scope of the appended claims.

What is claimed is:

1. A computer-implemented method for identifying offensive Internet files, the method comprising:
generating a model of user access time distribution patterns for a known offensive Internet file;
collecting user access information of a target Internet file;
compiling a user access time distribution pattern of the target Internet file;
comparing the user access time distribution pattern of the target Internet file with the model; and
identifying the target Internet file as offensive if its user access time distribution pattern is sufficiently similar to the model.

2. The method of claim 1, further comprising: collecting user access information of a second known offensive Internet file and using the collected information to generate the model.

3. The method of claim 1, further comprising: collecting user access information of the target Internet file for users in a first time zone and using the collected information to compile the user access time distribution pattern.

4. The method of claim 1, further comprising:
searching for Internet files matching a search request and generating a search result list; and
checking whether there is any offensive Internet file in the search result list before displaying the search result list.

5. The method of claim 4, further comprising: removing an offensive Internet file from the search result list.

6. The method of claim 4, further comprising: lowering a ranking of an offensive Internet file to put it at or near the end of the search result list.

7. The method of claim 1, wherein the model comprises a waveform of a number of clicks on the offensive Internet file over the course of a day.

8. The method of claim 1, wherein the model comprises a minimum number of clicks on the offensive Internet file over a period of time.

9. The method of claim 1, wherein the model comprises a ratio between a first number of clicks on the offensive Internet file in a first time period and a second number of clicks on the offensive Internet file in a second time period.

10. The method of claim 1, further comprising: updating the user access time distribution pattern of the target Internet file if it is clicked on.

11. A computer apparatus for identifying offensive Internet files, the apparatus comprising:
a controller for generating a model of user access time distribution pattern for a known offensive Internet file; collecting user access information of a target Internet file; compiling a user access time distribution pattern of the target Internet file; comparing the user access time distribution pattern of the target Internet file with the model; and identifying the target Internet file as offensive if its user access time distribution pattern is sufficiently similar to the model, and
a memory for storing the model and the user access time distribution pattern of the target Internet file.

12. The system of claim 11, wherein the controller further collects user access information of a second known offensive Internet file and using the collected information to generate the model.

13. The system of claim 11, wherein the controller further collects user access information of the target Internet file for users in a first time zone and using the collected information to compile the user access time distribution pattern.

14. The system of claim 11, wherein the model comprises a waveform of a number of clicks on the offensive Internet file over the course of a day.

15. The system of claim 11, wherein the model comprises a minimum number of clicks on the offensive Internet file over a period of time.

16. The system of claim 11, wherein the model comprises a ratio between a first number of clicks on the offensive Internet file in a first time period and a second number of clicks on the offensive Internet file in a second time period.

17. A system comprising:
a search engine for receiving search criteria and obtaining a list of Internet files matching the search criteria, and
a computer apparatus for identifying offensive Internet files according to claim 11,
wherein the search engine checks whether there is any offensive Internet files in the list before displaying the list.

18. The system of claim 17, wherein the search engine removes an offensive Internet file from the list.

19. The system of claim 17, wherein the search engine lowers a ranking of an offensive Internet file to put it at or near the end of the list.

20. A computer program product comprising a computer-readable medium having instructions which, when performed by a computer, perform a method for identifying offensive Internet files, the method comprising:
generating a model of user access time distribution pattern for a known offensive Internet file;
collecting user access information of a target Internet file;
compiling a user access time distribution pattern of the target Internet file;
comparing the user access time distribution pattern of the target Internet file with the model; and
identifying the target Internet file as offensive if its user access time distribution pattern is sufficiently similar to the model.
